(19) United States
(12) Patent Application Publication
(10) Pub. No.: US 2007/0005922 A1
(43) Pub. Date: Jan. 4, 2007

(54) Fully buffered DIMM variable read latency

(76) Inventors: Muthukumar P. Swaminathan, Bangalore (IN); Tessil Thomas, Bangalore (IN); Pete Vogt, Boulder, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,641

(22) Filed: Jun. 30, 2005

(51) Int. Cl. G06F 13/00; G06F 13/28

(52) U.S. Cl. 711/167

(57) ABSTRACT

Memory control that access memory devices having different read latencies is described. In on embodiment, a memory controller may include read latency logic to identify and match received read data with read commands to the memory devices based on values indicative of the read latency for the memory devices. In another embodiment, the memories may include read delay control to insert an amount of delay into the time a memory device takes in responding to a read command.

### BACKGROUND

With ever greater demands to be able to store and retrieve data ever more quickly, memory devices, including dynamic random access memory (DRAM) devices, have continued to become ever faster. With the increasing speed of the memory devices has been an accompanying need for increases in the speed of the memory interfaces and memory buses used to communicate addresses, commands and data with these memory devices. Concerns have arisen as to whether or not the long-accepted practices of busing the majority of signals provided by the memory interface of a memory controller to multiple memory devices, such as dual inline memory modules (DIMMs), as well as continuing to widen the data paths of such buses, will continue to be practical as the need for ever higher data transfer rates are required. The approach of busing signals to multiple memory devices adds loads to such signals which impede the ability to drive them with ever faster timings, and the approach of widening the data paths has become increasingly impractical since each such widening comes with an accompanying need to increase the number of pins of the package(s) of the memory controller(s) coupled to the memory devices through such buses.

As a result, interest has grown in defining an alternate way of coupling multiple memory devices to a memory controller through a series of point-to-point interconnects coupling DIMMs together in a chain topology with the memory controller being at on end of the chain. One developing form of such a series of point-to-point interconnects is the “fully buffered DIMM” (FBD) proposed standard currently being explored among multiple corporate entities through the Joint Electron Devices Engineering Council (JEDEC) of Arlington, Va. 22201, and which is expected to be released as a specification for industry use, possibly during the year 2005. In FBD, distinct address and data lines are dispensed with and a plurality of signals are employed in each interconnect to carry commands, addresses and data in packets across the point-to-point interconnects.

This use of a chain of point-to-point interconnects necessarily means that only one of the DIMMs in such a chain will be directly coupled to the memory controller, and that transfers between the memory controller and any of the other DIMMs in the chain will necessarily have to be relayed through intervening DIMMs, thereby incurring delays. It therefore follows that a DIMM with fewer intervening DIMMs between it and the memory controller will receive commands directed to it faster than a DIMM with a greater number of intervening DIMMs, and will be able to provide its response to a command back to the memory controller in less time, as well. Specifically, the amount of time required between the memory controller transmitting a command to read data from a given DIMM and the memory controller receiving the read data from the given DIMM (what is commonly referred to as the “read latency”) increases with each additional intervening DIMM between the memory controller and the given DIMM. Currently, there is no provision in the proposed FBD standard for the provision of identifying codes to be used in matching individual read commands transmitted by a memory controller to one or more DIMMs to packets containing data that are received from those DIMMs in response. The manner in which a given read command and a given packet of read data received in response are identified as corresponding to each other is by relying on the corresponding read latency being a known quantity such that the given packet of read data corresponding to the given read command is actually expected to be received by the memory controller at the end of a known period of time.

Given the use of read latency to identify which read command a received packet of data corresponds to, and a desire to minimize the design complexity of memory controllers to minimize cost, it has become accepted practice in designing memory controllers to work with the proposed FBD standard to configure delay logic provided within each DIMM such that regardless of how many intervening DIMMs there may be between a given DIMM and a memory controller, the memory controller will always receive a given packet of data corresponding to a given read command after the passage of a single read latency that is common to all of the DIMMs. In other words, DIMMs in a chain of point-to-point interconnects with fewer intervening DIMMs between them and a memory controller are configured to delay their transmission of a packet of read data in response to a read command longer such that the read latency is always the same from the perspective of the memory controller, regardless of which DIMM is involved in receiving and responding to a given read command, thereby making it easier to match a given received packet of read data with the read command that caused that packet to be sent to the memory controller.

Although this use of a single read latency in matching read commands to received packets of read data permits simpler memory controller designs, it also results in a lost opportunity to more quickly receive packets of read data from DIMMs having fewer intervening DIMMs between themselves and the memory controller through this deliberate use of delays in transmitting packets of read data.

### BRIEF DESCRIPTION OF THE DRAWINGS

The objects, features, and advantages of the present invention will be apparent to one skilled in the art in view of the following detailed description in which:

FIG. 1 is a block diagram of an embodiment employing a memory system.

FIG. 2 is a flow chart of an embodiment.

FIG. 3 is another block diagram of an embodiment employing a memory system.

FIG. 4 is another flow chart of an embodiment.

FIG. 5 is still another block diagram of an embodiment employing a memory system.

FIG. 6 is a block diagram of an embodiment employing a computer system.

FIG. 7 is a block diagram of an alternative embodiment employing a memory system.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern incorporating support to test and determine the read latency of multiple memory devices, and to record multiple read latencies to identify which read requests correspond to which pieces of received read data in an effort to allow multiple memory devices to supply read data in a manner that minimizes the use of deliberately inserted delays that would arbitrarily increase read latencies, thus speeding up overall memory system performance. Although at least part of the following discussion centers on memory devices within computer systems, it will be understood by those skilled in the art that the invention as hereinafter claimed may be practiced in connection with other electronic devices having memory devices. Also, although at least part of the following discussion centers on memory devices in the form of DIMMs that may be inserted or removed by end users, and centers on memory devices coupled to a memory controller through a single chain of point-to-point interconnects, those skilled in the art will readily recognize that other physical forms of memory devices and other configurations of coupling memory devices together as part of memory system may be employed.

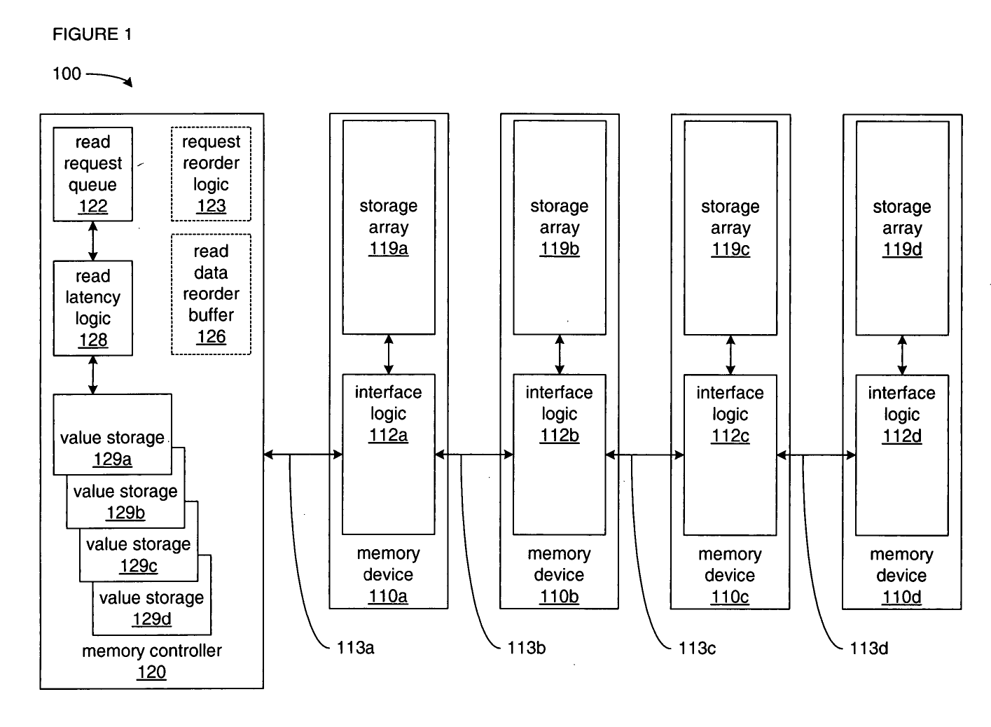

FIG. 1 is a simplified block diagram of one embodiment employing a memory system. Memory system 100 is, at least in part, made up of memory controller 120 and memory devices 110a-d coupled together via buses 113a-d in a single chain topology of point-to-point interconnects. Those skilled in the art of the design of memory systems will readily recognize that FIG. 1 depicts but one form of a relatively simple memory system, and that alternate embodiments are possible in which the exact arrangement and configuration of components may be reduced, augmented or otherwise altered without departing from the spirit and scope of the present invention as hereinafter claimed. For example, although memory system 100 is depicted as having buses coupling memory devices 110a-d together in a single chain of point-to-point interconnects to memory controller 120, it will be readily understood by those skilled in the art that other bus topologies may be used, including multiple parallel chains of point-to-point connections, branching (tree) point-to-point connections, or topologies in which a single bus couples multiple ones of memory devices 110a-d to memory controller 120 (i.e., a bus of a configuration other than point-to-point) may be used. Those skilled in the art will also readily recognize that although FIG. 1 depicts a set of four memory devices being present, memory system 100 may be made up of other quantities of memory devices.

Memory controller 120 controls the functions carried out by memory devices 110a-d as part of providing access to memory devices 110a-d to external devices (not shown) that are separately coupled to memory controller 120. Specifically, an external device coupled to memory controller 120 issues commands to memory controller 120 to store data within one or more of memory devices 110a-d, and to retrieve stored data from one or more of memory devices 110a-d. Memory controller 120 receives these commands and relays them to memory devices 110a-d in a format having timing and protocols compatible with bus 113a, 113b, 113c and/or 113d. In effect, memory controller 120 coordinates accesses made to memory cells within memory devices 110a-d in answer to read and write commands from external devices.

As previously discussed, each of buses 113a-d provides a point-to-point connection, i.e., a bus wherein at least the majority of the signals making up that bus connect between only two devices. Limiting the connection of the majority of signals to only two devices aids in maintaining the integrity and desirable electrical characteristics of that majority of signals, and thereby more easily supports the reliable transfer of high speed signals. Memory controller 120 is coupled to memory device 110a via bus 113a, forming a point-to-point connection between memory controller 120 and memory device 110a. In turn, memory device 110a is likewise further coupled to memory device 110b via bus 113b, memory device 110b is further coupled to memory device 110c via bus 113c, and memory device 110c is further coupled to memory device 110d via bus 113d. Addresses, commands and data transfer between memory controller 120 and memory device 110a, directly, through bus 113a, while addresses, commands and data must transfer between memory controller 120 and memory devices 110b, 110c and 110c through intervening memory devices and busses.

Buses 113a-d may be made up of various separate address, control and/or data signal lines to communicate addresses, commands and/or data, either on separate conductors or on shared conductors in different phases occurring in sequence over time in a multiplexed manner. Alternatively, or perhaps in conjunction with such separate signal lines, addresses, commands and/or data may be encoded for transfer in various ways and/or may be transferred in packets. Buses 113a-d may also communicate address, command and/or data parity signals, and/or error checking and correction (ECC) signals. As those skilled in the art will readily recognize, many forms of timing, signaling and protocols may be used in communications across a point-to-point bus between two devices. Furthermore, the exact quantity and characteristics of the various signal lines making up various possible embodiments of buses 113a-d may be configured to be interoperable with any of a number of possible memory interfaces, including widely used current day interfaces or new interfaces currently in development, such as FBD. In embodiments where activity on various signal lines is meant to be coordinated with a clock signal (as in the case of a synchronous memory bus), one or more of the signal lines, perhaps among the control signal lines, serves to transmit a clock signal across each of buses 113a-d.

Each of memory devices 110a-d are each made up of a corresponding one of interface logics 112a-d and storage arrays 119a-d, respectively, with corresponding ones of interface logics 112a-d and storage arrays 119a-d being coupled together within each of memory devices 110a-d. Storage arrays 119a-d are each made up of an array of memory cells in which the actual storage of data occurs. In some embodiments, storage arrays 119a-d may each be made up of a single integrated circuit, (perhaps even a single integrated circuit that also incorporates corresponding ones of interface logics 112a-d), while in other embodiments, storage arrays 119a-c may each be made up of multiple integrated circuits. In various possible embodiments, interface logics 112a-d are made up of one or more integrated circuits separate from the one or more integrated circuits making up storage arrays 119a-d, respectively. Also, in various possible embodiments, each of memory devices 110a-d may be implemented in the form of a SIMM (single inline memory module), SIPP (single inline pin package), DIMM (dual inline memory module), PCMCIA card, or any of a variety of other physical forms as those skilled in the art will recognize.

Interface logics 112a-d provide an interface between corresponding ones of storage arrays 119a-d and one or more of buses 113a-d to direct transfers of addresses, commands and data between each of storage arrays 119a-d and memory controller 120. In the case of memory device 110a, interface logic 112a directs transfers of addresses, commands and/or data intended to be between memory controller 120 and memory device 110a to storage array 119a, while allowing transfers of addresses, commands and/or data intended to be between memory controller 120 and other memory devices (such as memory devices 110b-d) to pass through interface logic 112a. In some embodiments of memory devices 110a-d, especially where storage arrays 119a-d are made up of one or more integrated circuits that are separate from interface logics 112a-d, interface logics 112a-d may be configured to provide an interface to storage arrays 119a-d that are meant to be compatible with widely used types of memory devices, among them being DRAM (dynamic random access memory) devices such as FPM (fast page mode) memory devices, EDO (extended data out), dual-port VRAM (video random access memory), window RAM, SDR (single data rate), DDR (double data rate), RAMBUS™ DRAM, etc.

As depicted in FIG. 1, memory controller 120 is made up, at least in part, of read request queue 122, read latency logic 128 and value storages 129a-d. As previously discussed, memory controller 120 receives requests for data to be read from one or more of memory devices 110a-d from an external device, such as a processor. Each of these read requests are stored in read request queue 122, at least until each read request is carried out. In carrying out these read requests, memory controller 120 transmits a read command across bus 113a towards memory device 110a, and as previously discussed, if the read command is directed at memory device 110a, then interface logic 112a within memory device 10a will direct it to storage array 119a, and otherwise, interface logic 112a will pass on the read command towards the other memory devices via bus 113b.

Memory controller 120 must wait for a period of time from the transmission of a read command to any one of memory device 110a-d to when memory controller 120 receives the requested read data back. In other words, there is a read latency associated with memory controller 120 transmitting a read command and receiving the requested read data. Memory controller 120 determines what the read latency is for each of memory devices 110a-d by carrying out one or more transactions with each of memory devices 110a-d and monitoring the amount of time that passes before a response is received from each of memory devices 110a-d. Memory controller 120 then stores values indicating read latencies for each of memory device 110a-d in corresponding ones of value storages 129a-d. As previously mentioned, though a quantity of four memory devices is depicted, memory system 100 may be made up of any of other quantities of memory devices, but whatever the quantity of memory devices actually making up memory system 100, there must be at least as many value storages provided within memory controller 120 so that a separate value indicative of read latency can be stored for each memory device present. During normal operation of memory system 100 in which read requests received from an external device and stored in read request queue 122 are carried out, read latency logic makes use of the values indicating read latencies for each of memory device 110a-d to aid in identifying which pieces of read data received from each of memory devices 10a-d corresponds to which read commands that were transmitted at earlier times. In other words, the previously determined read latencies for each of memory device 110a-d are used to determine when memory controller 120 should expect read data to be received in response to a given read command, thereby allowing each read command and each piece of read data that is received to be correctly matched so that ultimately, the external device to receive the correct piece of read data in answer to a given read request that was received by memory controller 120 and stored in read request 122.

At least one benefit of variable read latency is re-ordered responses. This can help improve performance, and be beneficial to leave the order as the response comes in.

In existing implementations, differences in the read latencies corresponding to each of memory devices 110a-d can cause issues with regard to the correct ordering of read data being provided to the requesting external devices coupled to memory controller 120. In other words, and by way of example, a first read request may be received from an external device for data stored within memory device 110d, followed by a second read request from the same external device for data stored within memory device 110a. Given that memory device 110a is directly coupled to memory controller 120, while memory device 110d is furthest away from memory controller 120 on the chain of buses 113a-d, it is possible that even if a first read command corresponding to the first read request is transmitted to memory device 110d before a second read command corresponding to the second read request is transmitted to memory device 110a, memory controller 120 may well receive a first read data corresponding to the second read command (and therefore, corresponding to the second read request) and then subsequently receive a second read data corresponding to the first read command (and therefore, corresponding to the first read request). Depending on the nature of the external device to which memory controller 120 is coupled and/or limits of that coupling, it may not be desirable for memory controller 120 to transmit the second read data corresponding to the second read request back to the external device before transmitting the first read data corresponding to the first request back to the external device. In other words, memory controller 120 may be required to maintain correct ordering of read data such that pieces of read data are transmitted to an external device in the same order in which their corresponding read requests were received from that external device. That is not the case with the teaching herein, where in one embodiment, the order is left in the order the response comes in.

In one variation of the embodiment of FIG. 1, the need to maintain correct ordering of read data may be addressed through the provision of request reorder logic 123 that makes use of the results of the earlier tests and determinations of read latencies of each of memory devices 110a-d to cause the read requests stored in read request queue 122 to be carried out in an order different from the order in which they were received by memory controller 120 so that the pieces of read data provided by memory devices 110a-d are received in the correct order for being transmitted back to an external device. Alternatively, in another variation, the need to maintain correct ordering of read data may be addressed through the provision of read data reorder buffer 126 that makes use of the order in which read requests are stored in read request queue 122 to reorder the pieces of read data received from memory devices 110a-d into an order that corresponds with the order in which the read requests were originally received for being transmitted back to an external device.

It should be noted that although the above example just discussed presumes that the relative placement of memory devices 110a-d determines the read latencies of each of memory devices 110a-d, those skilled in the art will readily recognize that read latencies are also, at least partially, determined by the relative internal timing characteristics of each one of memory devices 110a-d. Those skilled in the art will also readily recognize that it is entirely possible for one of memory devices 110a-d that is closer in the chain of buses 113a-d to memory controller 120 than another one of memory devices 110a-d to have such slow internal timing characteristics that such a closer one of memory devices 110a-d may actually have a read latency that is greater than the other one of memory devices 110a-d. In other words, differences in internal timing characteristics between different ones of memory devices 110a-d may conceivably overwhelm whatever effect on read latencies that may be caused by the relative positions of memory devices 110a-d.

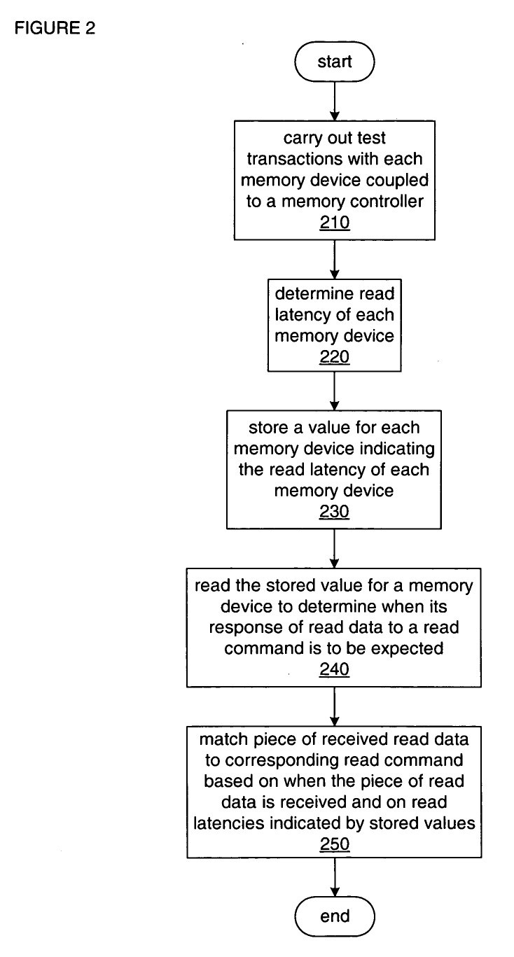

FIG. 2 is a flowchart of an embodiment. At 210, test transactions are carried out, either by or through a memory controller, involving each of a multitude of memory devices coupled (directly or indirectly) to the memory controller, and the read latencies of each of those memory devices is determined at 220. At 230, a value is stored that corresponds to and is indicative of the read latency of each one of those memory devices for later use in carrying out read requests. At 240, a read request is carried out in which the stored value corresponding to one of those memory devices is read, a read command is transmitted to that read device, and the stored value is used to determine when of read data sent by that memory device in response to that read command is to be expected. At 250, a piece of read data is received and is matched to the particular read command that elicited it from a memory device based on when the read data was received based on read latencies indicated by the stored values.

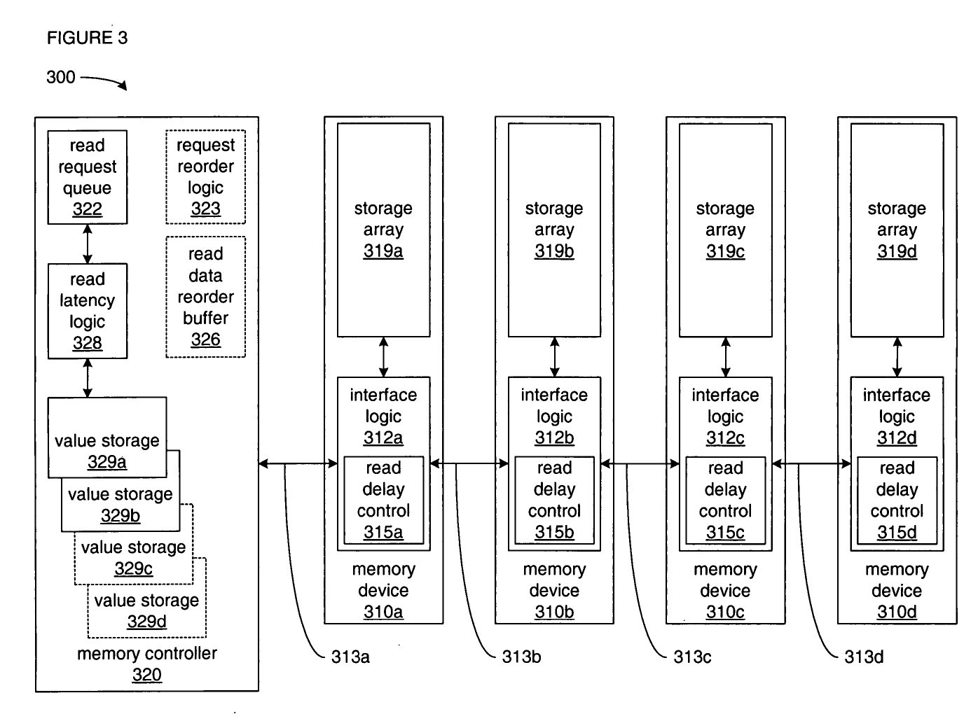

FIG. 3 is a simplified block diagram of another embodiment employing a memory system. In many respects, memory system 300 is similar to memory system 100 of FIG. 1 with corresponding components between memory systems 100 and 300 being labeled with numerals in which the last two digits are identical, and so the discussion that follows will tend to focus more on where memory systems 100 and 300 differ. In a manner not unlike memory system 100, memory system 300 is made up, at least in part, of memory controller 320 and memory devices 310a-d coupled together via buses 313a-d in a single chain topology of point-to-point interconnects. However, as was previously discussed with regard to memory system 100, other bus topologies may be used.

Like memory devices 110a-d, memory devices 310a-d are each made up of a corresponding one of interface logics 312a-d and storage arrays 319a-d, respectively, with corresponding ones of interface logics 312a-d and storage arrays 319a-d being coupled together within each of memory devices 310a-d. Each of interface logics 312a-d directs a command towards its corresponding one of memory arrays 319a-d or passes on a command to another of memory devices 310a-d, depending on which one of memory devices 310a-d a given command is directed to in a manner similar to what was previously discussed with regard to memory system 100.

Despite these and other similarities between memory devices 110a-d and memory devices 310a-d, memory devices 310a-d do differ from memory devices 110a-d in that each one of interface logics 312a-d is made up, at least in part, of a corresponding one of read delay controls 315a-d. Read delay controls 315a-d provide the ability to insert a selectable amount of delay in responding to a read command, thereby allowing the read latency of each of memory devices 310a-d to be individually increased by selectable amounts. In some embodiments, the timings and/or protocols of one or more of buses 313a-d may require that each of memory devices 310a-d have this ability to insert a selectable amount of delay so that the timing with which each of memory devices 310a-d responds to a read command with the transmission of read data back towards memory controller 320 can be synchronized with the timings of one or more of buses 313a-d. Specifically, one or more of buses 313a-d may be intended to provide defined “timing windows” or “frames” during which one of memory devices 310a-d may transmit read data, and read delay controls 315a-d provide a way to insert selectable amounts of delay such that memory devices 310a-d time their transmissions of read data to fit properly within those frames.

Like memory controller 120 of memory system 100, memory controller 320 controls the functions carried out by memory devices 310a-d as part of providing access to memory devices 310a-d to external devices (not shown) that are separately coupled to memory controller 320. Memory controller 320 is made up, at least in part, of read request queue 322, read latency logic 328, and in a manner not unlike memory controller 120, may be further made up of request reorder logic 323 or read data reorder buffer 326.

Despite these and other similarities between memory controller 120 and memory controller 320, memory controller 320 may differ from memory controller 120 in that unlike memory controller 120, where there had to be at least as many of value storages 129a-d as there were memory devices 110a-d so that an individual value indicative of read latency could be stored for each of memory devices 10a-d that were present in memory system 100, the provision of read delay controls 315a-d within memory devices 310a-d may allow memory controller 320 to have a quantity of value storages 329a-d that is less than the quantity of memory devices 310a-d that may be present in memory system 300. More specifically (and only as an example), as indicated by the dotted lines of value storages 329c and 392d, in some variations of embodiments, only value storages 329a and 329b may actually be present within memory controller 320, and this may be enabled by using some of read delay controls 315a-d within some of memory devices 310a-d to configure some of memory devices 310a-d with inserted delays that cause those memory devices to have the same read latencies as others of memory devices 310a-d, such that the quantity of values indicating read latencies that need be stored within memory controller 320 is reduced, thereby possibly providing an opportunity to simplify the design of memory controller 320.

Just as was the case with memory controller 120, memory controller 320 must wait for a period of time from the transmission of a read command to any one of memory device 310a-d to when memory controller 320 receives the requested read data back. However, unlike what was discussed with regard to memory controller 120, the presence of read delay controls 315a-d within memory devices 310a-d, respectively, may change some of how read latencies are determined and/or used. After initializing read delay controls 315a-d to insert no delays in their responses to read commands (or at least after initializing read delay controls 315a-d to minimize the duration of the inserted delays such that the inserted delays are no longer than what is required to meet bus timings and/or protocols for one or more of buses 313a-d), memory controller 320 determines what the read latency is for each of memory devices 310a-d by carrying out one or more transactions with each of memory devices 310a-d and monitoring the read latencies that are encountered.

In variations of embodiments where memory controller 320 has a quantity of value storages that is less than the quantity of memory devices present in memory system 300, memory controller 320 may, for example, store a subset of the read latencies encountered during the testing of the memory devices such that a value indicating the longest read latency encountered is stored along with at least one other value indicating a lesser read latency that was also encountered. Memory controller 320 may then configure one or more of read delay controls 315a-d to insert a delay such that one or more of memory devices 310a-d is configured to have a read latency equal to that of the longest read latency encountered, and memory controller may then configure one or more of the other of read delay controls 315a-d to insert a delay such that one or more of memory devices 310a-d is configured to have a read latency equal to one of the lesser read latencies encountered. In this way, memory devices 310a-d are configured such that there are two or more groups of memory devices among memory devices 310a-d that in which all of the memory devices within each group share a single read latency. For example, where there are only two value storages within memory controller 320, memory devices 310a-d may be configured such that there is a “fast group” made up of a subset of memory devices 310a-d that respond with a common shorter read latency, and a “slow group” made up of the other of memory devices 310a-d that respond with a common longer read latency (which would necessarily be the longest read latency encountered during testing). Of course, as those skilled in the art would recognize, there could be more than just two of such groupings of memory devices (e.g., there could be a “mid-speed” group of memory devices sharing a read latency that was somewhere midway between the read latencies of the fast and slow groups). In carrying out such testing and configuring of inserted delays for each of memory devices 310a-d, either memory controller 320 or an external device transmitting commands to memory controller 320 may temporarily track all of the read latencies encountered in the testing of each of memory devices 310a-d to facilitate choosing the read latencies that will be used and for which values will ultimately be stored in value storages.

In variations of embodiments where memory controller 320 has at least as many value storages as there are memory devices present in memory system 300, memory controller 320 may store separate values indicating read latencies for each of the memory devices that are present, as was previously discussed with regard to memory system 100, however, those separate values may be of latencies increased by delays selected and inserted through one or more of read delay controls 315a-d. Those inserted delays may be only enough to ensure proper operation of one or more of buses 313a-d, as previously discussed. Alternatively, one or more of those delays may be inserted to aid in avoiding timing contentions between memory devices over use of one or more of buses 313a-d. For example, in some variations of embodiments of memory system 300, the protocols of at least bus 313a may allow memory controller 320 to transmit multiple read commands, simultaneously, as an optimization. In such a case, if there were two memory devices that had the same read latency, then they may both attempt to use at least bus 313a to transmit their read data to memory controller 320 at the same time, thereby causing bus contention. A remedy may be to configure whichever one of read delay controls 315a-d makes up one of the two memory modules presenting this potential for conflict to insert a delay that causes that memory module's read latency to be increased such that it can no longer conflict with the other. Furthermore, regardless of their being a potential for conflict between two or more of memory devices 310a-d, one or more of read delay controls 315a-d may be configured to select delays that cause multiple ones of memory devices 310a-d to have read latencies that cause their responses to simultaneously transmitted read commands to be received by memory controller 320 in a closely spaced timing relationship such that memory controller 320 receives the responses of read data in adjacent frames or in “back-to-back” cycles that may allow memory controller 320 to operate more efficiently in some way (depending on the design of memory controller 320) as a result of grouping the receipt of multiple pieces of read data closely together in timing. The result might be arranged to closely resemble a form of “streaming” transfer of read data from a single memory device, even though the read data would be received from multiple memory devices.

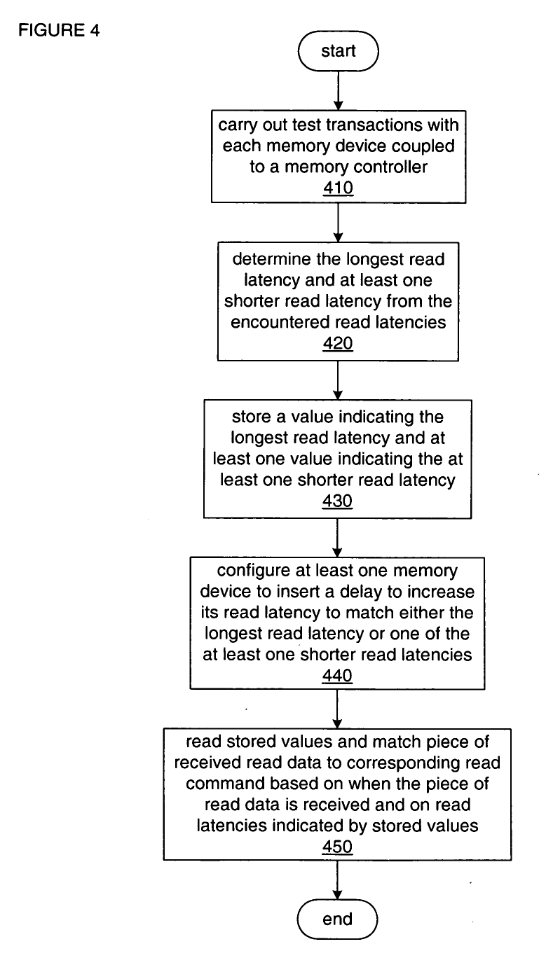

FIG. 4 is a flowchart of another embodiment. At 410, test transactions are carried out, either by or through a memory controller, involving each of a multitude of memory devices coupled (directly or indirectly) to the memory controller. From the tests at 410, the longest read latency is determined, along with at least one other shorter read latency at 420 for a total of at least two read latencies being determined. At 430, a value is stored that corresponds to and is indicative of the longest read latency, along with a value that corresponds to and is indicative of at least one shorter read latency. At 440, the memory devices that are present are grouped into at least two groups such that there is a group having at least the memory device with the longest latency, and at least one group having at least the memory device with the at least one shorter latency, and at least one other memory device is configured to insert a delay to have a read latency equal to either the longest read latency or the at least on shorter latency, thereby making it a part of one or the other of the groups. A larger quantity of such groups than just two may be created if a larger number of values corresponding to and indicative of read latencies is supported by the memory controller. At 450, the values corresponding to and indicating read latencies are read, a piece of read data is received and is matched to the particular read command that elicited it from a memory device based on when the read data was received based on read latencies indicated by the stored values.

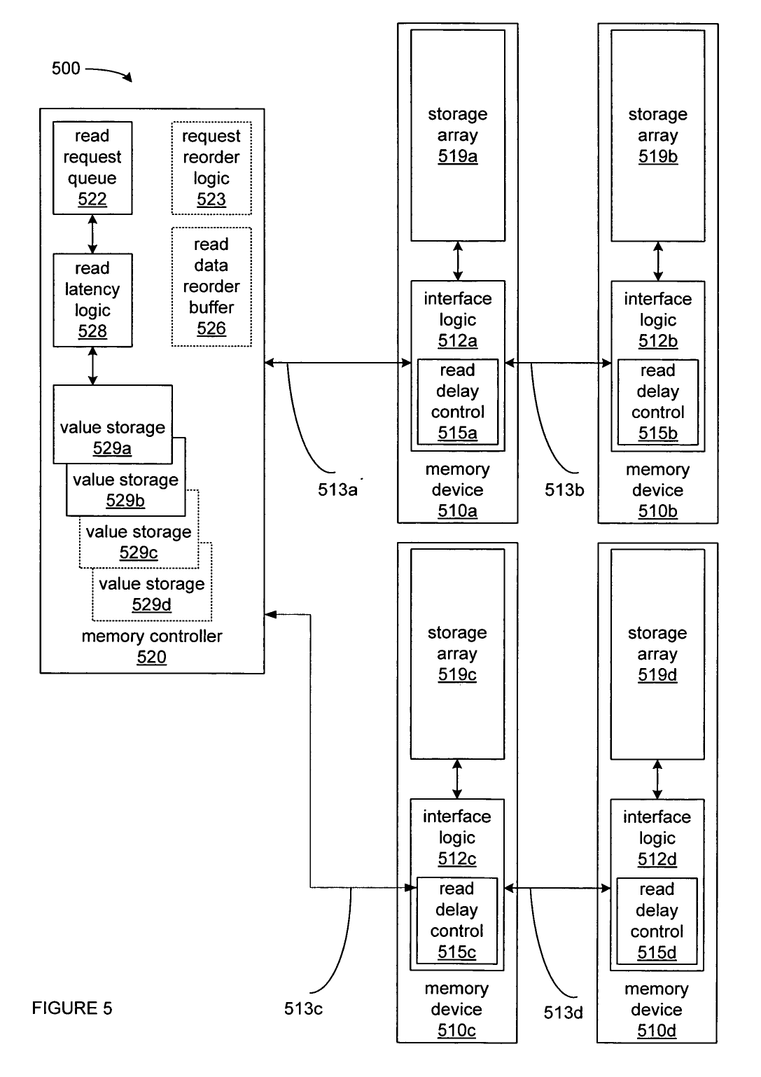

FIG. 5 is a simplified block diagram of still another embodiment employing a memory system. Memory system 500 is similar to memory system 300 of FIG. 3 with corresponding components between memory systems 300 and 500 being labeled with numerals in which the last two digits are identical. The most important difference between memory systems 300 and 500 is the differing topologies of buses 313a-d and buses 513a-d. While buses 313a-d of memory system 300 followed a topology of a single chain of point-to-point interconnects, buses 513a-d of memory system 500 follow a topology of a pair of parallel chains of point-to-point interconnects, in which buses 513a and 513c directly couple memory devices 510a and 510c, respectively, to memory controller 520, and in turn, buses 513b and 513d couple memory devices 510b and 510d to memory device 510a and 510c, respectively, to create the parallel chains.

Like memory devices 310a-d, memory devices 510a-d are each made up of a corresponding one of interface logics 512a-d and storage arrays 519a-d, respectively, with corresponding ones of interface logics 512a-d and storage arrays 519a-d being coupled together within each of memory devices 510a-d. Furthermore, each one of interface logics 512a-d is made up, at least in part, of a corresponding one of read delay controls 515a-d providing the ability to insert a selectable amount of delay in responding to a read command, thereby allowing the read latency of each of memory devices 510a-d to be individually increased by selectable amounts.

Like memory controller 320, memory controller 520 is made up, at least in part, of read request queue 522, read latency logic 528, and in a manner not unlike memory controller 520, may be further made up of request reorder logic 523 or read data reorder buffer 526. Furthermore, the provision of read delay controls 515a-d within memory devices 510a-d may allow memory controller 520 to have a quantity of value storages 529a-d that is less than the quantity of memory devices 510a-d that may be present in memory system 500. As was discussed with regard to memory system 300, the provision of read delay controls 515a-d provides the ability to configure some of memory devices 510a-d to have read latencies that match others of memory devices 510a-d, thereby allowing subsets of memory devices 510a-d to be grouped by read latencies.

For example, where there are only two value storages within memory controller 520, memory devices 510a-d may be configured such that there is a “fast group” made up of a subset of memory devices 510a-d that respond with a common shorter read latency, and a “slow group” made up of the other of memory devices 510a-d that respond with a common longer read latency (which would necessarily be the longest read latency encountered during testing). Given the topology of buses 513a-d depicted in FIG. 5, it is possible that memory devices 510a and 510c may be grouped together as the “fast group” while memory devices 510b and 510d may be grouped together as the “slow group” due largely to memory devices 510a and 510c being directly coupled to memory controller 520 while memory devices 510b and 510d are the opposite end of chains of point-to-point interconnects from memory controller 520. Of course, as those skilled in the art would recognize, there could be more than just two of such groupings of memory devices (e.g., there could be a “mid-speed” group of memory devices sharing a read latency that was somewhere midway between the read latencies of the fast and slow groups).

In determining groupings of memory devices among memory devices, memory controller 520 may carry out one or more test transactions with each of memory devices 510a-d to determine the read latencies of each of memory devices 510a-d, determine what the longest read latency is (which will become the read latency of the slow group), and to both determine and choose a shorter read latency that will become the common read latency of the fast group. In carrying out such testing and configuring of inserted delays for each of memory devices 510a-d, either memory controller 520 or an external device transmitting commands to memory controller 520 may temporarily track all of the read latencies encountered in the testing of each of memory devices 510a-d to facilitate choosing the read latencies that will be used and for which values will ultimately be stored in value storages. Based on the results of these tests, a slow group having at least the one of memory devices 510a-d that has the slowest read latency is defined and is given the longest read latency as the common read latency for that group, and at least a fast group having at least one of the other memory devices 510a-d that was found to have a shorter read latency is defined and is given that shorter read latency as the common read latency for that group. The remaining ones of memory devices 510a-d are distributed among the two groups (keeping in mind that although four memory devices are depicted, there could be a greater or lesser quantity of memory devices actually present) such that those that have read latencies that are longer than the common read latency of the fast group are placed in the slow group and their read delay controls are configured to insert delays to increase their read latencies to match that of the longest read latency, and such that those that have read latencies that are shorter than the common read latency of the fast group are placed in the fast group and their read delay controls are configured to insert delays to increase their read latencies to match that of the shorter read latency that is common to the fast group.

As those skilled in the art will recognize, the way of selecting which memory devices belong to which group that has just been discussed is based on the read latencies encountered from each memory device, and although it may be likely that memory devices that are more closely coupled to memory controller 520 will be grouped into the fast group, this is not necessarily the case as one or more of the memory devices that are more closely coupled to memory controller 520 may have internal timing characteristics that result in their having relatively long read latencies. In an alternative way of determining which of memory devices 510a-d may be to make the assumption that memory devices coupled directly to memory controller 520 will have shorter read latencies than memory devices that are further away in each of the parallel chains of point-to-point interconnects, and therefore, memory devices 510a and 510c are always grouped together into what is presumed to be the fast group, and memory devices 510b and 510d are always grouped together into what is presumed to be the slow group. As part of creating these groupings in this way, tests are carried out to determine the longest read latencies out of the memory devices in each of these groups, the values indicating the longest latencies encountered in each of these groups are stored in the value storages of memory controller 520, and the longest read latency encountered in each group becomes the common read latency for all memory devices in that group and those memory devices that have shorter read latencies than the longest read latency within each group are configured through their read delay controls to insert delays that will cause the read latencies of all memory devices within each group to match the common read latency within that group.

Although not actually depicted in FIG. 5, in a variation of embodiments, a branching bus coupler (not shown) may be interposed between memory controller 520 and both buses 513a and 513c with a single bus coupling the branching bus coupler to memory controller 520. In such a variation, the grouping of memory devices into at least two different groups may still proceed either through testing of all memory devices and determining grouping based entirely on the lengths of the read latencies encountered, or through the assumption that memory devices that are more closely coupled to memory controller 520 (despite being coupled through a branching bus coupler) will have shorter read latencies than memory devices that are not as closely coupled and carrying out tests of the memory devices within each group to determine the common read latencies for each group.

Also, like what was previously discussed with regard to the testing of read latencies in memory system 300, timing and/or protocol requirements of one or more of buses 513a-d may necessitate read delay controls 515a-d of one or more of memory devices 510a-d being configured to insert delays to cause the transmission of read data in response to read commands to be synchronized to properly occur within allotted frames. In so configuring memory devices 510a-d, the delays to be inserted may be selected to avoid adding delays beyond what is necessary to resolve such timing issues.

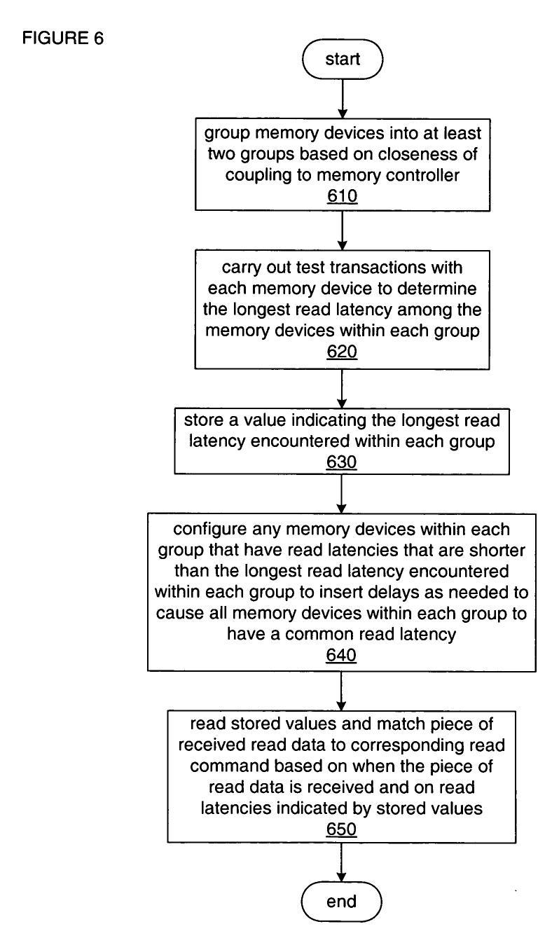

FIG. 6 is a flowchart of still another embodiment. At 610, memory devices are grouped into at least two groups based on how closely coupled they are to a memory controller. This is done based on the previously discussed generalization that memory devices that are more closely coupled to a memory controller are more likely to have shorter read latencies. Tests are then carried out at 620 to determine the longest read latencies of the memory devices present within each group, with the longest read latency encountered within each group becoming the common read latency to be used with all memory devices present in each group. At 630, values are stored that correspond to and indicate of the longest read latencies found in each group of memory devices. At 640, any memory devices present in each group that have read latencies that are shorter than the longest read latency encountered in each group (which are now the common read latencies within each group) are configured to insert delays to cause those memory devices to have read latencies equal to the longest latencies encountered in each group. At 650, the values corresponding to and indicating read latencies are read, a piece of read data is received and is matched to the particular read command that elicited it from a memory device based on when the read data was received based on read latencies indicated by the stored values.

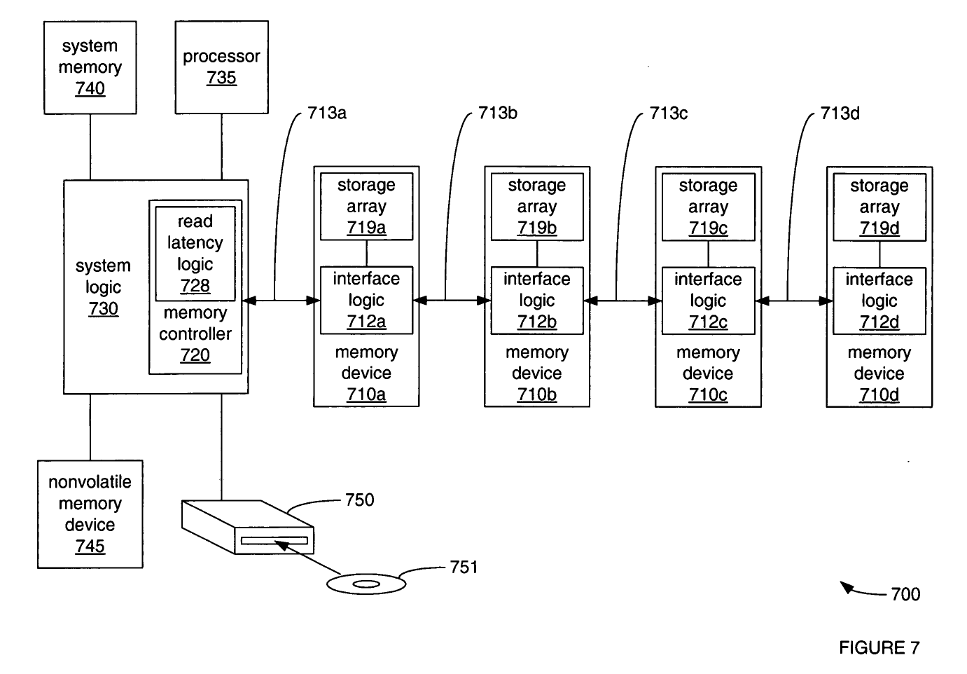

FIG. 7 is a simplified block diagram of one embodiment employing a memory system. Memory system 700 is, at least in part, made up of system logic 730 and memory devices 710a-d coupled together via buses 713a-d in a single chain topology of point-to-point interconnects.

As depicted in FIG. 7, system logic 730 is made up, at least in part, of memory controller 720 and read latency logic 728.

During normal operation of memory system 700 in which read requests received from an external device and stored in system logic 730 are carried out, read latency logic makes use of the values indicating read latencies for each of memory device 710a-d to aid in identifying which pieces of read data received from each of memory devices 710a-d corresponds to which read commands that were transmitted at earlier times.

Also coupled to the system logic 730 is processor 735, system memory 740, non-volatile memory 745, and a compact disc player 750 (with compact disc 751).

What is claimed is:

1. An apparatus comprising:
a storage to store a plurality of values, each of the plurality of values indicative of read latency for a memory device in a plurality of memory devices;
a read request queue to store read requests; and
read latency logic coupled to the storage and the read request queue to identify each set of received read data as matching to a read command to one of the plurality memory devices based on the plurality of values.

2. The apparatus defined in claim 1 further comprising a read reorder buffer, responsive to read commands ordered in the read request buffer, to reorder received read data into an order in which the read commands were received into the read request queue.

3. The apparatus defined in claim 1 further comprising request reorder logic.

4. A memory device comprising:
a storage array; and
interface logic coupled to the storage array and responsive to read and write requests, wherein the interface logic comprises read delay control to insert an amount of delay in responding to a read command.

5. The memory device defined in claim 4 wherein the amount of delay is programmable.

6. The memory device defined in claim 4 wherein the storage array is part of a dual in-line memory module (DIMM).

7. A method comprising:
reading a stored value for a memory device to determine when a response of read data to read commands is to be expected, the value being indicative of the read latency for the corresponding memory device; and
identifying received read data received as corresponding to a read command to the memory device based on the value.

8. The method defined in claim 7 further comprising determining the read latency of each of the plurality of memory devices.

9. The method defined in claim 7 further comprising storing a value for each of the plurality of memory devices.

10. The method defined in claim 7 wherein identifying received read data received as corresponding to a read command to the memory device is also based on the received read data.

11. A method comprising:
determining read latency of each of the plurality of memory devices;
configuring at least one of the plurality of memory devices based on the determined read latency values; and
identifying received read data received as corresponding to a read command to one of the plurality of memory devices based on a value indicative of its read latency.

12. The method defined in claim 11 wherein configuring at least one of the plurality of memory devices comprises inserting a delay to increase a read latency of one of the plurality of memory devices.

13. The method defined in claim 12 wherein the delay increases the read latency to match the longest read latency of memory devices in the plurality of memory devices.

14. The method defined in claim 12 wherein the delay increases the read latency to match the shortest read latency of memory devices in the plurality of memory devices.

15. The method defined in claim 11 wherein configuring at least one of the plurality of memory devices comprises inserting delays to cause all memory devices in the plurality of memory devices to have a common read latency.
